(19) United States
(12) Patent Application Publication
(10) Pub. No.: US 2008/0316873 A1
(43) Pub. Date: Dec. 25, 2008

(54) SYSTEMS AND METHODS FOR IMPROVING PERCEIVED START-UP TIME FOR A DVD PLAYER

(75) Inventor: Joshua Robey, Hollis, NH (US)

Correspondence Address: Weiss & Arons, LLP, 1540 Route 202, Suite 8, Pomona, NY, 10970, US

(73) Assignee: Broadcom Corporation, Irvine, CA (US)

(21) Appl. No.: 11/766,832

(22) Filed: Jun. 22, 2007

(51) Int. Cl. G11B 7/085

(52) U.S. Cl. 369/30.32

(57) ABSTRACT

Systems and method for initializing the software for an optical disc player are provided. The optical disc player may include an operating system, an application framework, and a disc loader comprising a disc tray. The method may also include, in response to receiving a tray open request, executing a board support package. The package supports a loading of the operating system and may establish a communication protocol with the loader. Finally, the package may execute a disc tray open command code. One embodiment of the method may conclude by loading the operating system.

### BACKGROUND OF THE INVENTION

This application relates to software for a DVD disc player or other suitable optical disc player. More specifically, this application relates to coordinating software commands in the initialization of the DVD.

One of the usability metrics for a DVD player is how quickly the player responds when someone first starts to use the player. That is, how long does someone have to wait for a player response when he or she wants to play a movie from a DVD. This metric may typically be measured from the first user action—e.g., pressing the ON button or pressing the tray open button—to when the DVD player responds—e.g., when the player opens the disc loader door to receive a DVD. It would be desirable to reduce the time from the first user action to when the player responds.

### SUMMARY OF THE INVENTION

A system and/or method for initializing the operation of a DVD player, substantially as shown in and/or described in connection with at least one of the figures, as set forth more completely in the claims.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a timeline of a conventional method of initializing a conventional DVD player;

FIG. 2 is a timeline of a method of initializing a DVD player according to the invention;

FIG. 3 is a schematic drawing of an optical disc player;

FIG. 4 is a hybrid software/hardware schematic drawing of a DVD player according to the invention; and

FIG. 5 shows a schematic diagram of a single or multi-chip module of this invention in a data processing system.

### DETAILED DESCRIPTION OF THE INVENTION

This invention is directed to methods and systems of improving, under certain conditions, the time from a first user action, such as pressing a button on the front panel to open the loader tray of the DVD loader, to the first significant reaction from an operations standpoint from the DVD player. Opening the disc loader tray of the DVD player may be considered an example of a first significant reaction. This invention is also directed to improving the perceived time from first user action to playing the movie. While the examples described herein are directed to a DVD player, it should be understood that the scope of this application extends to all suitable players of optical discs.

Most conventional DVD players can be in one of three states when idle: ON, standby, and OFF. In the ON state, the player is fully powered up and all software modules of the player are ready to operate. In this state, player response time to a user event is usually relatively quick.

In the standby state, most modules of the player are powered down and the central processing unit (CPU) is either operating in a low power mode or is OFF. In this state, response to a user event often requires the CPU to be powered up, the board support software to run and initialize, the operating system to be booted or restored from a saved state, the application framework (that initializes the internal components of the system such as the audio system, the video system, the user display interface) to run, and many other software modules of the system to be powered up and/or initialized. Typical response time from the standby state is often tens of seconds.

In the OFF state, the transition to the ON state is similar to the transition to the ON state from the standby state, but even more time-consuming. In this state, all of the modules of the system are completely OFF. Thus, response to a user event requires powering ON and initializing all of the modules of the system, including powering up the CPU and running the board support package, the operating system, and the application software. Typical response time may even exceed the time set forth above for the standby state.

There are typically four events that can cause a DVD player to go from the standby or OFF state to the ON state. These are: 1) the user presses the ON/OFF button on the front panel, 2) the user presses the tray open/close button on the front panel, 3) the user presses the ON/OFF button on the remote control, 4) the user presses the tray open/close button on the remote control.

A great majority of the time, when the user initiates one of the four events that causes the DVD to go from standby or OFF to the ON state, there is no disc in the tray. Consequently, when a user wants to play a movie from a DVD, the most common user action is to open the tray either using the tray open button on the front panel or the tray open button on the remote control. Therefore, it follows that the first user action is to press the tray open button either on the remote control or on the front panel.

Once a user presses the tray open button, the user must wait for the tray to open before the user can proceed to place the DVD in the tray. In conventional DVD players, it is believed that the system fully transitions from the standby or OFF state to the ON state before accessing the loader driver to open the disc tray. This is true even though there is no internal system requirement that the DVD loader tray can only open when the entire system is ready to play a movie.

To reiterate, in such conventional players, the system completes the entire start-up sequence including operating system boot or restore and application framework load before the tray open command is executed.

One embodiment of the present invention preferably adds software code to the board support package code of the software (which typically executes before, and supports the loading of, the operating system) that has sufficient support to communicate with the hardware interface for the disc loader and send it the command to open the tray. (Alternatively, an embodiment of the invention could include code in the operating system code that performs the additional functions of communicating with the hardware interface for the disc loader and sending the command to open the tray.) It should be noted that the software code that is added to the board support package code of the software to send the command to open the tray does not have to be the entire driver for the disk loader interface. Rather, in one embodiment of the invention, the code that may be added to the board support package may only include code sufficient to establish the communication protocol with the loader and send one loading command such as a disc tray open command. This additional software code does not have to maintain state of the communication with the loader tray or establish an entire driver interface.

The boot up sequence can continue during the time the tray is opening and then when the opening of the tray has completed—i.e., the tray has reached a fully open position. Thus, the boot-up sequence can complete the board support package, load the operating system and then load the application framework and, substantially simultaneously thereto, the user can be inserting the disc into the tray and pressing the remote control close button or front panel close button to close the tray. Once the loading is complete, or, as will be described in more detail below, prior thereto, the system can close the tray and start reading the disc.

Accordingly, this invention reduces the time that the user experiences prior to the start of the movie because it allows multiple functions to occur substantially in parallel. Furthermore, because the user is actively engaged in loading the disc during the boot-up of the DVD, the perceived time to the start of the movie is significantly less than in conventional DVD players. Most importantly, a response to the user disc open request may be provided within a relatively short time period following the request.

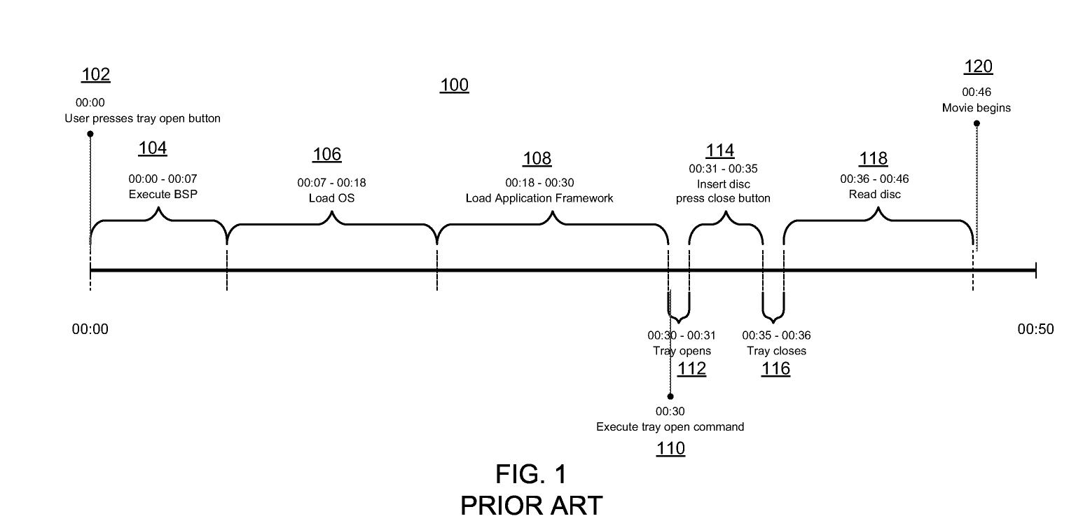

FIG. 1 shows a conventional timing sequence 100 of the boot-up cycle—i.e., the initialization—of a DVD player from a powered-OFF state to a state at which a movie on a DVD can be played. Sequence 100 begins at step 102 when the user presses the tray open button of the DVD player. It should be noted that, while timing sequence 100 has been described herein as relating to a boot-up cycle from a powered-OFF state, nevertheless, sequence 100 may also be understood to relate to a boot-up cycle from a standby state, as described in more detail above.

Step 104 shows executing the board support package software. Typically, the board support package provides support for the initialization of the operating system (OS). Once the board support package has provided requisite support for the initialization of the OS, the board support package typically does not play a role in the further operation of the DVD player. Step 104 may take about 7 seconds. (It should be noted that all the various times described in this application are: 1) approximate and 2) system dependent—i.e., these times can vary widely among different DVD players—and the invention is not limited to any particular times described herein, except as claimed by the claims which follow.)

Step 106 shows loading the OS. The OS is the program that, after being initially loaded into the computer by a board support package or other boot program, manages the other programs in a computer. The other programs are typically called applications or application programs. These applications may make use of the operating system by making requests for services through a defined application program interface (API). Step 106 may take about 11 seconds. The operating system may also include a number of operating system drivers including, but not limited to, an optical disc loader driver.

Step 108 shows loading the application framework. The application framework may initialize internal components of the systems such as the audio system, the video system, the display user interface and navigators. Each of the navigators may support playing of an optical media. Preferably, different navigators support different optical media. Step 108 may take about 12 seconds.

Step 110 shows issuing an open tray command. The open tray command 110 is issued in response to the user pressing the open tray button at step 102, although the open tray command occurred about 30 seconds prior thereto.

Once the tray opens at step 112, step 114 shows an approximate time of five seconds that elapses when the user places the disc in the tray and presses the close button. Step 116 shows about a two second time period that elapses as the tray closes.

Step 118 shows a 10 second time period that elapses when the DVD player reads the DVD in preparation for the showing of the movie at step 120. Step 120, the playing of the DVD, commences about 46 seconds following the user pressing the tray open button.

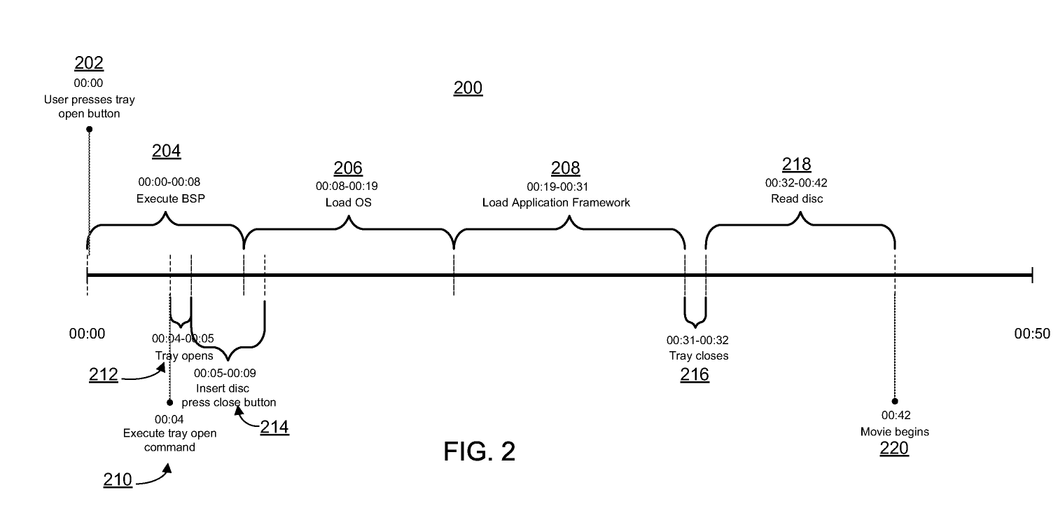

FIG. 2 shows a timeline of a method according to the invention. The functionality described in steps 202, 204, 206, 208, 218, and 220 is substantially similar to steps 102, 104, 106, 108, 118, and 120 shown in FIG. 1.

A difference between the conventional timeline shown in FIG. 1 and the timeline of the method according to the invention can be seen in the location of steps 210, 212 and 214. In the method according to the invention, steps 210 (execute tray opening), 212 (tray opening), and 214 (inserting disc and pressing close button) most preferably commence during the loading of the board support package 204 and are completed considerably before the termination of the loading of the application framework.

In FIG. 2, steps 210, 212, and 214 are shown as beginning during the latter stage of the loading of the board support package and step 214 is shown as being completed during the initial stage of the loading of the OS. The change in location of steps 210, 212, and 214 with respect to the overall timeline obtains numerous advantages according to the invention. One advantage is that the time that was used for the opening of the disc tray and inserting the disc into the tray, which, as shown in the conventional method in FIG. 1, added additional time to the total of time elapsed from when the user pressed the tray open button and the actual playing of the movie, has been used more efficiently. This more efficient use of the time for opening of the disc tray and inserting the disc into the tray is attributable to the fact that the processes described in steps 210, 212, and 214 are running substantially simultaneously—i.e., in parallel—with the other steps in the DVD initialization process.

Another advantage obtained by the method according to the invention preferably includes keeping the user occupied during the relatively long interval between the user pressing the tray button and the opening of the tray; about a 30 second period in this example. By opening the tray prior to the completion of the initialization of the application framework, the user's attention is engaged for at least a portion of this 30 second period and preferably does not lose interest during the DVD player initialization process. Accordingly, in addition to providing a method according to the invention of reducing the actual time elapsed until the start of the movie, a method according to the invention preferably even more significantly reduces perceived time until the start of the movie because the attention of the user is diverted to loading the tray during the time that the user would be waiting idly for the disc tray to open.

In FIG. 2, it can be seen that a method according to the invention actually reduces the total time from the user pressing the tray button until the movie beginning from about 46 seconds to about 42 seconds. As such, the total time has been reduced by about eight percent.

While FIG. 2 shows step 216 (tray closing) taking place following the completion of step 208 (the loading application framework), nevertheless, it is within the scope of this invention to add additional tray closing code into the board support package (or the OS code) such that, upon receiving a trade close command during, for example, the loading of the OS, the tray closing could occur. As such, the slightly more than one second associated with the tray closing could be saved as well and the total time associated with loading can be reduced in total by about 10 percent.

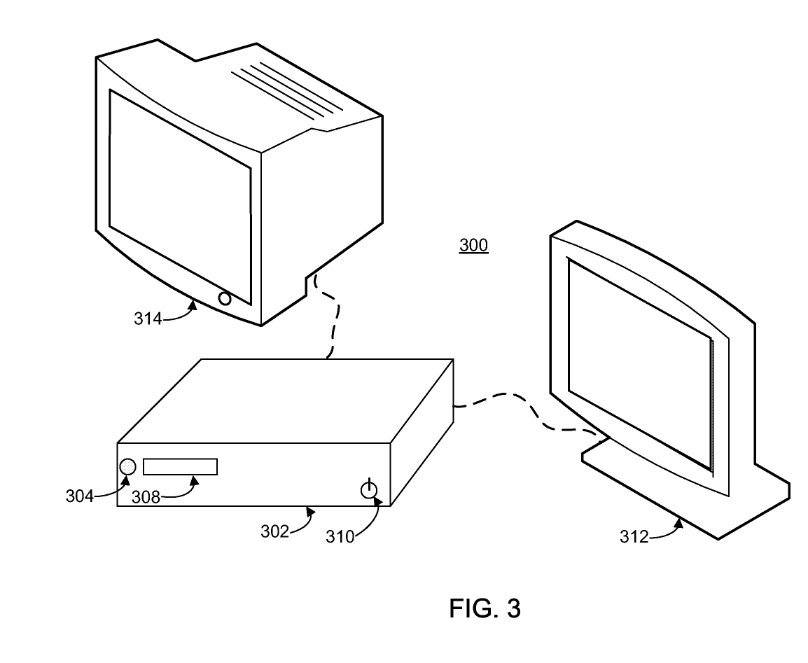

FIG. 3 shows a schematic diagram of an exemplary DVD player 302 and monitor 312 (an alternative monitor is shown at 314) that may be implemented with a method according to the invention and/or that may contain code according to the invention. Player 302 includes a tray open/tray close button 304, a DVD disc loader 308, and ON/OFF button 310. Monitor 312 (and alternative monitor 314) may include any suitable monitor including, but not limited to, a High Definition TV monitor, a flat panel monitor or a CRT monitor, each of which may be intrinsic to or external from DVD player 302.

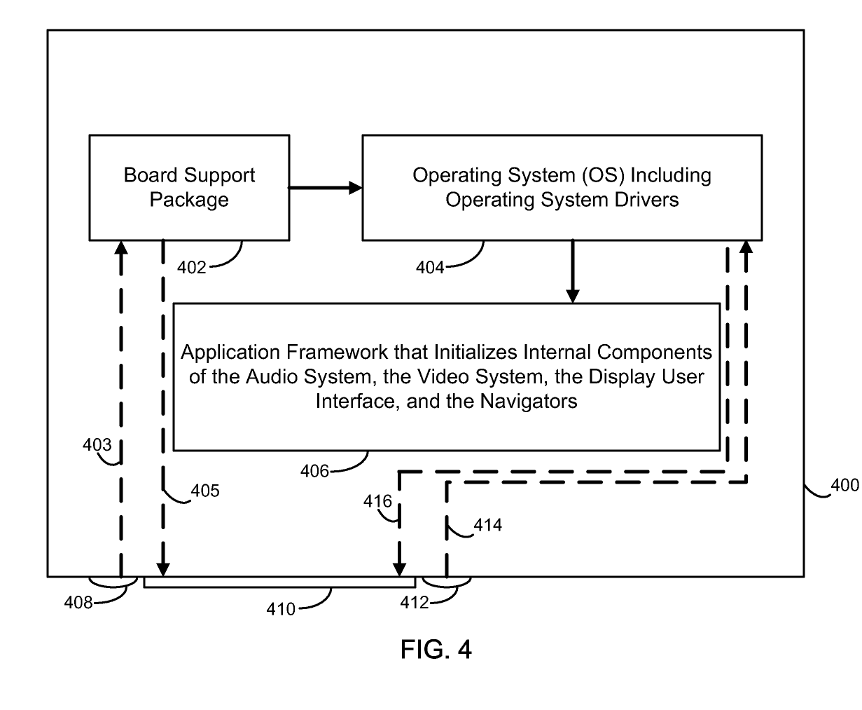

FIG. 4 is a hybrid software/hardware schematic drawing of a DVD player according to the invention. More particularly, FIG. 4 shows a schematic diagram of one possible embodiment of the initialization software according to the invention resident inside DVD player 400. FIG. 4 shows that when a user presses tray open button 408, this preferably loads the board support package 402, as shown along line 403. Thereafter, the board support package may perform two operations according to the invention. The board support package may prepare for the loading of the operating system and the board support package may, according to the invention, establish a communication protocol with, and send a tray open command to, DVD disc loader 410, as shown along line 405. Thereafter, the OS can load at 404 (at least partially) substantially simultaneously with the opening of the loader tray. Thus, the user is provided the ability to insert the DVD or other optical disc into the system while the board support package is preparing for the initialization of the operating system and the OS is initializing.

Then, following the loading of the OS at 404, DVD player 404 can load the application framework that initializes internal components of the audio system, the video system, the display user interface, and the navigators at 406.

It is further shown that once the user has loaded the disc into the disc tray and pressed the close tray button at 412 (the functionality of open button 408 and close button 412 may be combined into a single button as shown, for example, in FIG. 3), as shown at line 414, the system can preferably close the tray at an appropriate time during or after the loading of the operating system as shown at line 416. This closing action preferably assumes that the appropriate instruction code for closing the tray has already been loaded into the system.

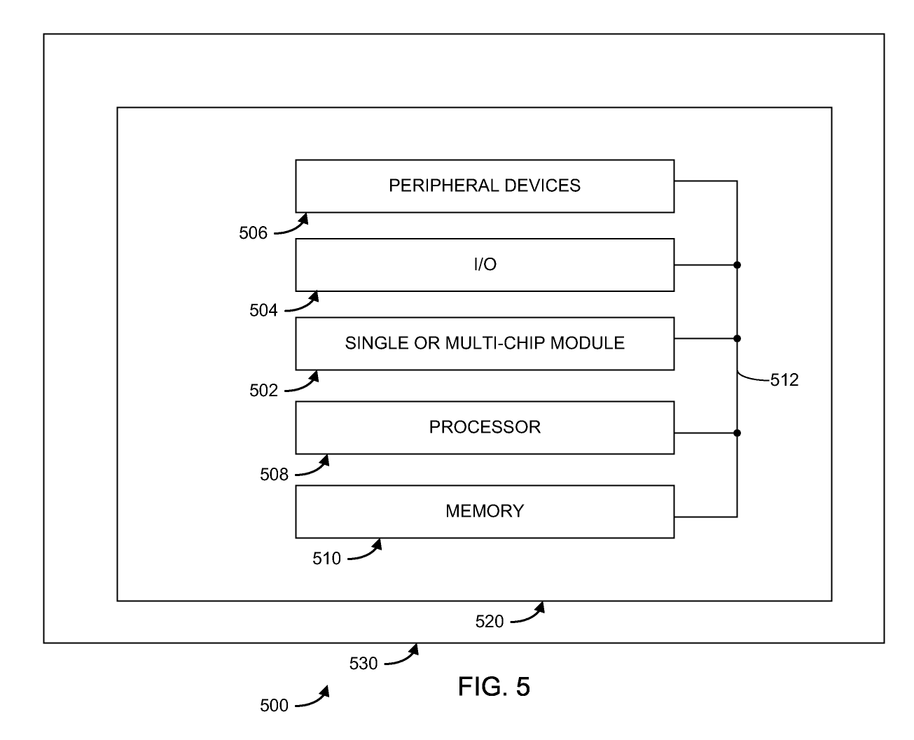

FIG. 5 shows a single or multi-chip module 502 according to the invention, which can be one or more integrated circuits, in a data processing system 500 according to the invention. Data processing system 500 may include one or more of the following components: I/O circuitry 504, peripheral devices 506, a processor 508 and memory 510. These components are coupled together by a system bus or other interconnections 512 and are populated on a circuit board 520 which is contained in an end-user system 530. System 500 is configured for use in a DVD player according to the invention. It should be noted that system 500 is only exemplary, and that the true scope and spirit of the invention should be indicated by the following claims.

Thus, systems and methods for improving actual and perceived start-up time for a DVD player according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. A method of initializing the software for an optical disc player, the optical disc player software comprising a board support package that supports the initialization of an operating system, the operating system comprising a plurality of drivers, an application framework, the application framework that initiates an optical disc player video system and an optical disc player audio system, and a disc tray, the method comprising:
in response to receiving a tray open request, executing the board support package;
loading the operating system and the operating system drivers;
loading the application framework; and
prior to the completion of the loading the application framework, opening the disc tray.

2. The method of claim 1 further comprising initiating the opening of the disc tray during the executing of the board support package.

3. The method of claim 1 further comprising completing the opening of the disc tray during the initializing of the operating system.

4. The method of claim 1 the receiving the tray open request further comprising receiving in a stand-by state the tray open request.

5. The method of claim 1 the receiving the tray open request further comprising receiving in a powered-OFF state the tray open request.

6. The method of claim 1 further comprising receiving a tray close request during the loading of the operating system.

7. The method of claim 6 further comprising executing a tray close code during the loading of the operating system.

8. The method of claim 6 further comprising executing a tray close code during the loading of the application framework.

9. The method of claim 1 further comprising receiving a tray close request during the loading of the application framework.

10. The method of claim 9 further comprising executing a tray close code during the loading of the application framework.

11. The method of claim 1, further comprising establishing a communications protocol between the board support package and a DVD disc loader, the DVD disc loader that comprises the disc tray.

12. An apparatus for use in an optical disc player, the apparatus comprising:
a board support package code;
an operating system code;
an application framework code; and
a disc loader;
wherein, in response to receiving a tray open request, the player executes the board support package code, the board support package code that supports an initialization of the operating system, establishes a communication protocol with the disc loader and communicates a disc tray open command to the disc loader.

13. The apparatus of claim 12 wherein the disc loader completes the opening of a disc tray during the initializing of the operating system code.

14. The apparatus of claim 12 further comprising code that receives the tray open request in a stand-by state.

15. The apparatus of claim 12 further comprising code that receives the tray open request in a powered-OFF state.

16. The apparatus of claim 12 further comprising code that is adapted to receive and respond to a tray close request received during the loading of the board support package code.

17. The apparatus of claim 12 further comprising code that is adapted to receive and respond to a tray close request received during the loading of the operating system code.

18. The apparatus of claim 12 further adapted to execute a tray close code during loading of the application framework code.

19. The apparatus of claim 12 further comprising code that is adapted to execute a tray close code during the loading of the application framework.

20. A digital processing system comprising:
processing circuitry;
a memory coupled to said processing circuitry; and
apparatus as defined in claim 12 coupled to the processing circuitry and the memory.

21. A printed circuit board on which is mounted apparatus as defined in claim 12.

22. The printed circuit board defined in claim 21 further comprising:
a memory mounted on the printed circuit board and coupled to the apparatus.

23. The printed circuit board defined in claim 21 further comprising:
processing circuitry mounted on the printed circuit board and coupled to the apparatus.

24. A method of initializing the software for an optical disc player, the optical disc player comprising a board support package, the operating system, an application framework, and a disc loader comprising a disc tray, the method comprising:
in response to receiving a tray open request, executing the board support package, the package that supports a loading of the operating system, establishes a communication protocol with the loader, and executes a disc tray open command code; and
following the executing of the board support package, loading the operating system.

25. The method of claim 24, further comprising completing the opening of the disc tray during the loading of the operating system.

26. The method of claim 24, the receiving the tray open request further comprising receiving in a stand-by state the tray open request.

27. The method of claim 24, the receiving the tray open request further comprising receiving in a powered-OFF state the tray open request.

28. The method of claim 24, further comprising receiving a tray close request during the loading of the operating system.

29. The method of claim 24, further comprising executing a tray close code during the loading of the operating system.

30. The method of claim 24, further comprising executing a tray close code during the loading of an application framework, said loading of an application framework occurring after the loading of the operating system.
